(19) United States
(12) Patent Application Publication
(10) Pub. No.: US 2013/0134253 A1
(43) Pub. Date: May 30, 2013

(54) Power Rotor Drive for Slowed Rotor Winged Aircraft

(71) Applicant: Jay W. Carter, JR., Burkburnett, TX (US)

(72) Inventor: Jay W. Carter, JR., Burkburnett, TX (US)

(73) Assignee: Carter Aviation Technologies, LLC, Wichita Falls, TX (US)

(21) Appl. No.: 13/305,441

(22) Filed: Nov. 28, 2011

(51) Int. Cl. B64C 27/00

(52) U.S. Cl. 244/17.11

(57) ABSTRACT

A rotor aircraft has an engine having an output shaft. At least one propeller is driven by the engine to provide forward thrust to the aircraft. Wings provide lift while in forward flight. A rotor is driven by rotor drive mechanism, which selectively provides torque to the rotor drive shaft from the engine while in a first mode. The rotor drive mechanism selectively provides torque to the rotor drive shaft to rotate at a speed independent of a speed of the output shaft of the engine while in a second mode. In one embodiment, the rotor drive mechanism is a variable speed transmission powered by the engine. In another embodiment, the rotor drive mechanism is an electric motor.

### FIELD OF THE INVENTION

This invention relates in general to an aircraft having a rotor for providing lift for take off, landing and optionally hovering, and wings for providing lift at high forward speeds, the aircraft having a drive mechanism that rotates the rotor at slowed speeds during high speed forward flight.

### BACKGROUND

A type of slowed rotor aircraft, sometimes called a gyroplane, is illustrated in U.S. Pat. No. 5,727,754. The aircraft has a rotor similar to a helicopter blade rotor. The aircraft has a propeller that provides forward thrust, and wings for providing substantially all of the lift in cruise flight. The rotor blades have weighted tips to create inertia. The aircraft in the '754 patent will perform a jump takeoff by rotating the rotor at a fairly high speed while the collective pitch is at zero and the landing gear brakes on. The propeller is also rotated prior to takeoff. The collective pitch is then increased to a takeoff level and the brakes released, which causes the aircraft to lift. A clutch disengages the engine from the rotor at the moment of takeoff, but the inertia of the rotor continues spinning the rotor during the take-off. As the aircraft gains forward speed, the wings will begin providing the lift required to maintain the aircraft in flight. As the aircraft forward flight speed increases, the rotor is tilted back relative to the fuselage and reduced in collective pitch to at or near zero. This causes the rotor to auto-rotate during high speed forward flight. The auto-rotation of the rotor occurs due to the air stream passing through the rotor blades. The aircraft of the '754 patent does not have the ability to hover.

In U.S. Pat. No. 6,513,752, the rotor aircraft has propellers on each wing. The aircraft is capable of hovering by causing the engine to drive the rotor. While hovering, the propellers are controlled to prevent the fuselage from spinning in reaction to the torque imposed by the engine on the rotor. During cruise flight, a clutch releases the rotor from the engine and the rotor is tilted and trimmed to auto-rotate.

### SUMMARY

The slowed rotor winged aircraft as described herein has a rotor drive means to rotate the rotor at a desired slow speed during cruise flight. The rotation is not auto-rotation due to the airstream flowing through the rotor; rather it is due to the rotor drive means being capable of rotating the rotor at a speed independent of the speed of the engine, which also drives the forward thrust device or propeller. The rotor drive means has one mode that selectively provides torque to the drive shaft from the output of the engine at a speed that is proportional to the speed of the output shaft of the engine. That mode may be used for pre-rotating the rotor for a jump takeoff, for a rotor powered takeoff, or for hovering. The rotor drive means has a second mode that selectively provides torque to the rotor drive shaft to rotate at a speed independent of the speed of the output shaft of the engine. The second mode is used during cruise flight.

Sensors will sense the flight conditions of the aircraft. The aircraft has a controller that controls the rotary drive means while in the second mode in response to the input from the sensors. During the second mode, the wings will provide substantially all of the lift required. The rotor is trimmed to provide substantially zero lift during cruise flight. The rotor drive means continues to provide torque to the rotor drive shaft to maintain a desired minimum rotational speed of the rotor during cruise flight.

In one embodiment, the rotor drive means comprises an electric motor coupled to the rotor drive shaft. A clutch may be mounted between the output shaft of the engine and the rotor drive shaft. The clutch is released when the rotor drive means is in the second or forward flight mode. Consequently during the second mode, the engine does not provide any torque to the rotor drive shaft. The clutch is located such that the electric motor is able to supply torque to the rotor drive shaft while the clutch is released. While in the first mode, the clutch is engaged, thereby causing the output shaft of the engine to apply torque to the rotor drive shaft.

In another embodiment, the rotor drive means comprises a transmission having an input connected to the output shaft of the engine and an output that is variable to the rotational speed of the input. The output of the transmission may be infinitely variable in speed relative to the output shaft of the engine. Alternately, the transmission may have multiple gear ratios of the input speed to output speed.

### BRIEF DESCRIPTION OF THE DRAWINGS

FIG. 1 is a top view of a slowed rotor winged aircraft having a rotor drive means that is capable of driving the rotor during cruise flight at a speed independently of the engine.

FIG. 2 is a schematic illustrating the principle drive components for the propellers and the rotor of the aircraft of FIG. 1 and employing a variable speed transmission between the engine and the rotor.

FIG. 3 is a schematic similar to FIG. 2, but illustrating an electric motor that drives the rotor of the aircraft of FIG. 1 during cruise flight.

FIG. 4 is a perspective view of a second embodiment of a rotor aircraft having a rotor drive means in accordance with this disclosure.

FIG. 5 is a schematic illustrating the main drive components for the propeller and the rotor of the aircraft of FIG. 4 and employing a variable speed transmission between the engine and the rotor.

FIG. 6 is a schematic similar to FIG. 5, but illustrating an electric motor that drives the rotor of the aircraft of FIG. 5.

### DETAILED DESCRIPTION

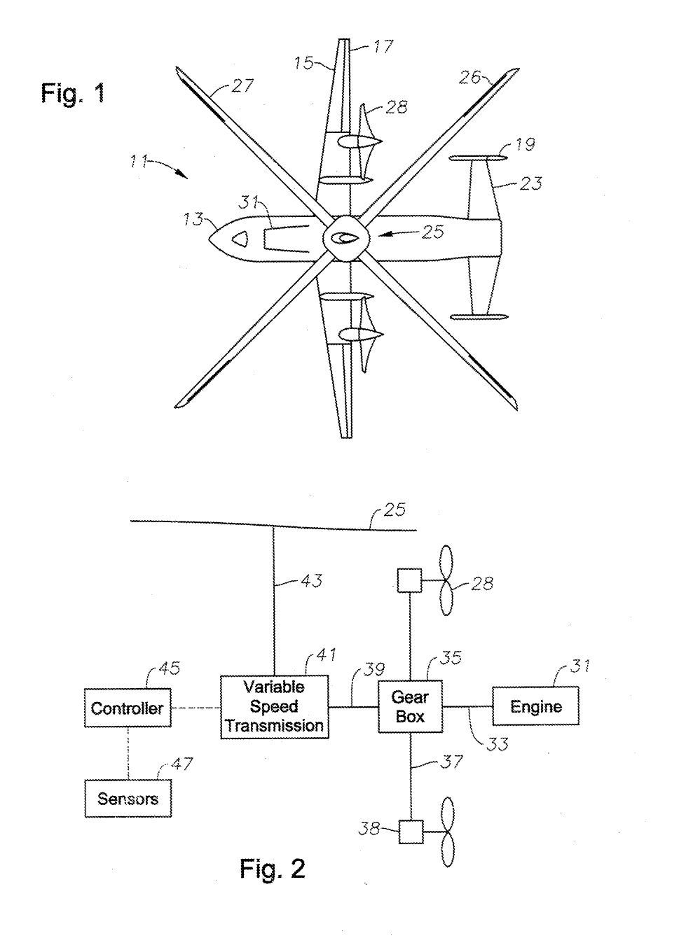

Referring to FIG. 1, aircraft 11 has a fuselage 13. A pair of high aspect ratio wings 15 extends outward from fuselage 13. The length of each wing 15 over the chord between the leading edge and trailing edge is quite high so as to provide efficient flight at high altitudes. Wings 15 preferably have ailerons 17 that extend from the tip to more than half the distance to fuselage 13. Each aileron 17 has a width that is about one-third the chord length of wing 15 and is moveable from a level position to a full ninety degrees relative to the fixed portion of each wing 15.

Aircraft 11 also has a pair of vertical stabilizers 19, each of which has a moveable rudder. Each vertical stabilizer 19 is mounted at the aft end of fuselage 13 on a horizontal airfoil and structural member that is referred to herein as a stabilator 23.

A rotor 25 extends upward from fuselage 13 and supports at least one pair of blades 27 and preferably two pairs as shown. Rotor 25 may be tiltable in forward and rearward directions relative to fuselage 13. Blades 27 are weighted at their tips by weights 26 for increasing stiffness at high rotational speeds and for creating inertia. Each blade 27 comprises a shell that encloses a longitudinal twistable carbon fiber spar (not shown). The spar is continuous through the shell and attaches to the shell at approximately 40 percent of its radius. Each blade 27 is pivotal to various collective pitches about a centerline extending from rotor 25.

A forward thrust device, which in this instance comprises a propeller 28, is mounted to each wing 15 on each side of fuselage 13. In this embodiment, propellers 28 are pusher types. Other devices to provide forward thrust to aircraft 11 are possible. Each propeller 28 has a continuous carbon fiber spar (not shown) that runs from blade tip to blade tip. Each carbon fiber spar is twistable inside a shell of each propeller 28 to vary the collective pitch. Changing the pitch of one of the propellers 28 can change the direction of airflow generated by the propeller 28 from a rearward direction to a forward direction. Changing the pitch to cause the air flow in a forward direction can counter the rotational torque produced by rotor 25 while it is being driven and aircraft 11 hovering. A tail rotor as in a conventional helicopter is not needed. Propellers 28 always rotate counter to each other. However, when rotational torque of rotor 25 is to be countered, one propeller 28 is pitched for reverse thrust while the other may be pitched for forward thrust. The difference between the two pitches will provide a counter torque that is controlled to equal the rotational torque produced by rotor 25.

FIG. 1 schematically illustrates a power source 31 that drives rotor 25 and propellers 28. Power source 31 may comprise a variety of engines, including multiple gas turbine engines located within fuselage 13. The terms “power source” and “engine” may be used interchangeably herein. Referring to FIG. 2, power source 31 has an output drive shaft 33 that leads to a main gear box 35. Propeller drive shafts 37 extend in opposite directions from gear box 35 and connect to right angle drive gear units 38. The output shaft of each right angle drive gear unit 38 rotates one of the propellers 28.

Main gear box 35 has another output shaft that comprises a transmission input shaft 39 of a variable speed transmission 41. Variable speed transmission 41 has an output comprising rotor drive shaft 43. A controller 45 is linked to variable speed transmission 41 so as to vary the speed of rotor drive shaft 43 relative to transmission input shaft 39. Variable speed transmission 41 may be of various types, including one that infinitely varies the output speed relative to the input speed. One example of an infinitely variable transmission has a belt drive with a pulley that has two halves that can move toward and away from each other to vary the width of the pulley. As the width of the pulley decreases, the belt extending over it is pushed farther from the axis of rotation to change the speed of the belt. Alternately, rather than an infinitely variable speed transmission, another type of variable speed transmission may be one that shifts the input and output between a number of gears.

A number of flight condition sensors 47 are linked to controller 45. These sensors 47 may include ones that sense the following: airspeed; angle of attack of wings 15; torque applied to rotor drive shaft 43; lift provided by rotor 25; and rotational speed of rotor drive shaft 43. Other conditions may also be sensed. Controller 45 includes a processor that computes a desired rotational speed or torque to be applied to rotor drive shaft 43 depending upon the flight conditions sensed.

In operation of the embodiment of FIG. 2, for a powered jump take-off, variable speed transmission 41 is set by controller 45 so that power source 31 continues supplying torque to rotate rotor 25 at a high speed, even after take-off. In this mode, rotor 25 will be rotating at a speed proportional to the output speed of power source 31. The collective pitch of one or both of the propellers 28 is controlled to counter the rotational torque imposed by torque supplied to rotor drive shaft 43. As aircraft 11 gains forward flight speed, controller 45 will control variable speed transmission 41 to slow the rotational speed of rotor 25, and wings 15 will assume more of the lift. At cruise flight, controller 45 will control variable speed transmission 41 to maintain a minimum rotational speed of rotor 25. Control 45 and variable speed transmission 41 will rotate rotor 25 at a speed independent of the output speed of power source 31. The collective pitch of rotor 25 will be trimmed to be near or at zero, and substantially all of the lift will be provided by wings 15. Rotor 25 will not needed to be tilted aft to auto-rotate in response to the airstream flowing through it. The torque to cause rotor 25 to rotate during cruise flight will continue to come from power source 31, but at a level, that is independent of the speed of power source 31 or propellers 28. This level of torque imposed on drive shaft 43 will be quite low because rotor 25 is rotating slowly and not providing any significant lift. Consequently, the pitch of propellers 28 likely need not be adjusted to counter this low amount of torque.

For hovering, the collective pitch of rotor 25 will be changed so that rotor 25 will be providing all the lift, rather than wings 15. Controller 45 will control variable speed transmission 41 to supply sufficient torque to rotor 25 to cause it to rotate at a desired rotational speed. The collective pitch of one or both of propellers 28 will be changed to counter the rotational torque during hovering. The speed of rotor 25 will be proportional to the output speed of power source 31 during hovering. Rotor 25 may also be driven by power source 31 at a high rotational speed during short landings.

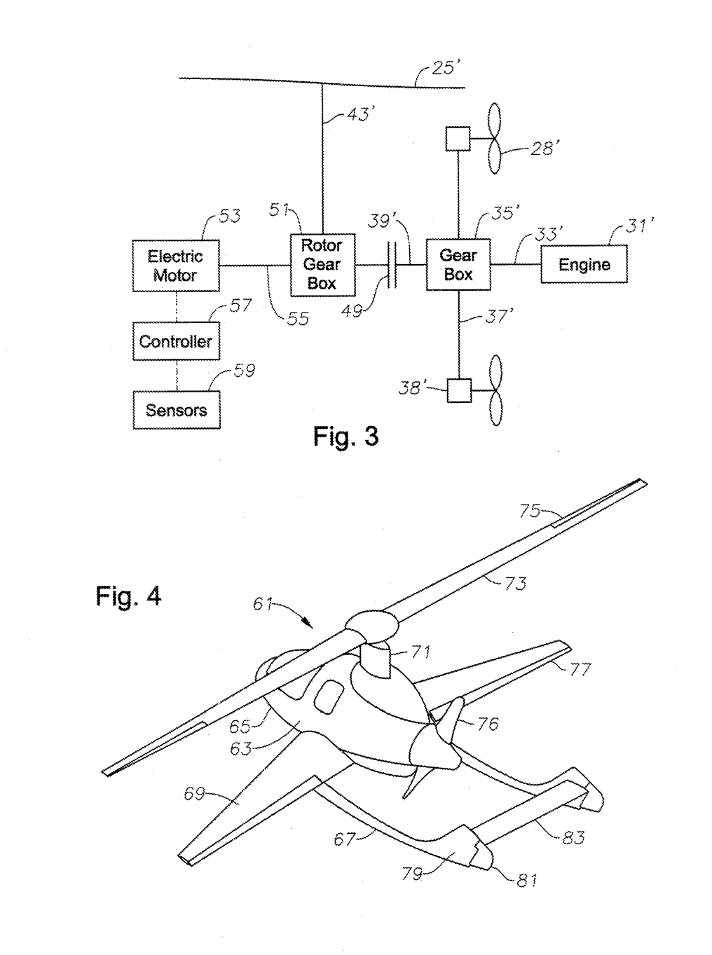

Referring to FIG. 3, in this alternate embodiment, a variable speed transmission is not employed as the rotor drive means. For components that are the same as in FIG. 2, the same numerals are employed, but with a prime symbol. Power source 31′ has an output shaft 33′ that drives main gear box 35′ in the same manner as in FIG. 2. Similarly, propeller drive shafts 37′ extend from main gear box 35′ to right angle gear units 38′ for driving propellers 28′. An output shaft 39′ from main gear box 35′ connects to a clutch 49. The opposite side of clutch 49 connects to a rotor gear box 51. When clutch 49 is engaged, power source 31′ supplies torque to the input of rotor gear box 51 to rotate rotor 25′ at a speed proportional to the output speed of power source 31′.

An electric motor 53 has an output shaft 55 connected to an input of rotor gear box 51. An output of rotor gear box 51 connects to rotor drive shaft 43′. When clutch 49 is released, electric motor 53 supplies torque to rotate rotor drive shaft 43′ rather than power source 31′. Electric motor 53 is a variable speed motor and need not have a large output torque. Electric motor 53 is employed only to rotate rotor 25′ at a minimum slow speed during cruise flight. A controller 57 controls electric motor 53 and optionally clutch 49. Sensors 59 of the same general type as sensors 47 sense flight conditions and provide information to the processor of controller 57.

In the operation of the embodiment of FIGS. 1 and 3, for a powered jump take-off, clutch 49 will be engaged so that power source 31′ supplies torque through rotor gear box 51 to rotate rotor 25′ at a high speed. Once the aircraft leaves ground, one or both of the propellers 28′ are controlled to counter the rotational torque imposed by torque supplied to rotor drive shaft 43′. Electric motor output shaft 53 may spin in reverse, causing electric motor 53 to act as a generator. Once the aircraft gains adequate forward speed for substantially all the lift to be supplied by wings 15 (FIG. 1), the collective pitch of rotor 25 is reduced to zero or near zero. Controller 57 will disengage clutch 49 and cause electric motor 53 to rotate rotor drive shaft 43′ via rotor gear box 51. At cruise flight, controller 57 will control electric motor 53 to maintain a minimum rotational speed of rotor 25′. At cruise flight, substantially all of the lift will be provided by wings 15. Rotor 25′ will not need to be tilted to auto-rotate in response to the airstream flowing through it. The torque to cause rotor 25′ to rotate during cruise flight will come from electric motor 53 at a level that is independent of the speed of power source 31′ or propellers 28′. This level of torque will be quite low because rotor 25′ is rotating slowly and not providing lift. Consequently, propellers 28 need not be set to counter this low amount of torque.

For hovering, the collective pitch of rotor 25′ will be changed so that rotor 25′ will provide all the lift, rather than wings 15. Controller 57 will re-engage clutch 49, which causes rotor shaft 43′ to be driven by power source 31′. The collective pitch of one or both of propellers 28 will be changed to counter the rotational torque during hovering.

FIG. 4 illustrates a rotor aircraft 61 that differs from aircraft 11 of FIG. 1. Aircraft 61 has a fuselage 63 with a forward portion 65 and a twin tail rearward portion 67. The forward portion 65 of the fuselage 63 supports a pair of fixed wings 69, each having an aileron 77. A mast 71 supports a high inertia rotor 73. Rotor 73 has two blades in this example, each blade having weights 75 at its tips. A single propeller 76 is mounted on the rear portion of fuselage 63 and faces rearward. Vertical stabilizers 79 are mounted on each tail portion 67. A rudder 81 is mounted to the aft edge of each vertical stabilizer 79. An elevator 83 extends between vertical stabilizers 79.

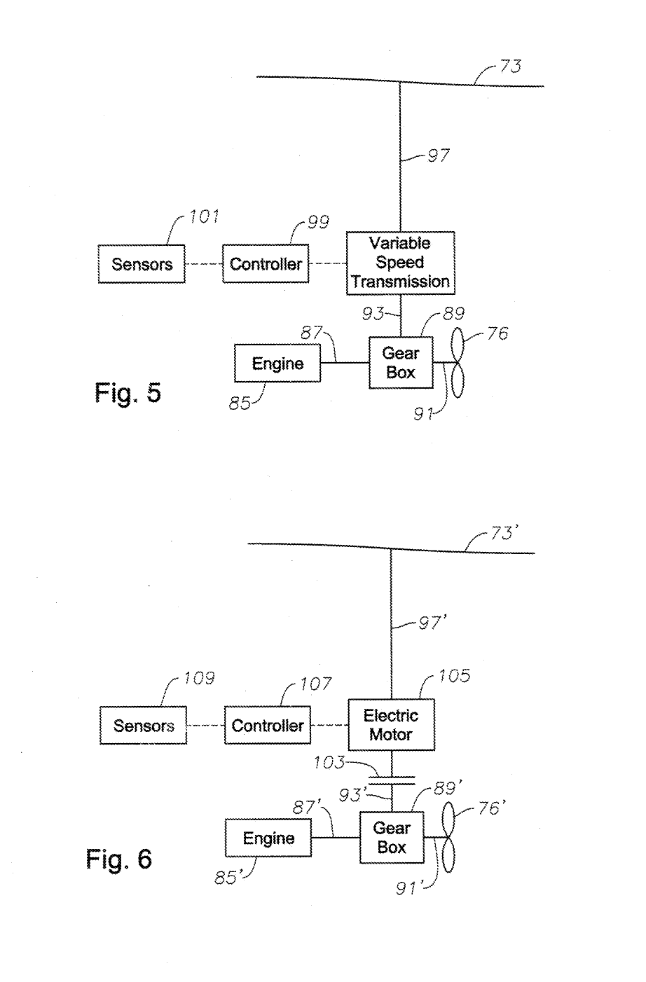

Referring to FIG. 5, an engine 85 has a first output shaft 87 that extends to a main gearbox 89. Gearbox 89 drives propeller shaft 91, which in turn rotates propeller 76. Gearbox 89 also has a second output shaft 93 that is connected to a variable speed transmission 95. Variable speed transmission 95 may be the same general type as variable speed transmission 41 of FIG. 2. Variable speed transmission 95 has an output that drives a rotor drive shaft 97, which in turn rotates rotor 73. A controller 99 is linked to variable speed transmission 95 so as to vary the speed of rotor drive shaft 97 relative to transmission input shaft 93. A number of flight condition sensors 101 are linked to controller 99. These sensors 99 may sense the same flight conditions as sensors 47 of FIG. 2. Controller 99 includes a processor that computes a desired rotational speed or torque to be applied to rotor drive shaft 97.

In the operation of the embodiment of FIGS. 4 and 5, aircraft 11 is designed for inertia jump take-offs, not rotor powered take-offs. The pilot will hold the landing gear brakes on while rotating propeller 76 and pre-rotating rotor 73 with engine 85. Controller 99 will select a desired output torque and speed for variable speed transmission 97. The collective pitches of propeller 76 and rotor 73 will be near or at zero during pre-rotation. When the desired rotor speed has been achieved, the collective pitches for propeller 76 and rotor 73 are changed to a take-off position and the landing gear brakes are released. At the same time, controller 99 causes variable speed transmission 95 to change to a take-off setting. In the take-off setting, very little torque of engine 93 passes to rotor 73, rather the inertia from the tip weights 75 (FIG. 4) maintains a high rotational speed. Lift will be provided primarily by rotor 73 initially. Even though rotor 73 is still driven by engine 85 as the aircraft lifts, there will be very little reaction torque produced by rotor 73 because it will be rotating primarily due to inertia. As the aircraft gains forward speed, wings 69 begin providing lift and rotor 73 slows due to the controller 99 changing variable speed transmission 95.

At cruise flight, the collective pitch of rotor 73 will be reduced to zero or near zero. Controller 99 will causes variable speed transmission to rotate rotor 73 at a minimum slow speed. The pilot will not tilt rotor 73 to cause auto-rotation, rather the rotational force will be coming from engine 85. Because rotor 73 is providing very little lift during cruise flight, there will be very little torque produced by engine 85 that needs to be countered. There is no clutch between main gearbox 89 and rotor drive shaft 97; rather engine 85 always remains in driving engagement with rotor drive shaft 97.

For a short landing, the collective pitch of rotor 73 is increased, which will cause an increase in speed of rotor 73 as the aircraft descends. If needed, controller 95 may increase the torque supplied to rotor drive shaft 97 by engine 85 as the aircraft descends to maintain a selected rotational speed. However, any significant torque imposed by engine 85 during descent would need to be countered by controlling various flight control surfaces of the aircraft.

FIG. 6 illustrates aircraft 61 (FIG. 4) with an alternate drive arrangement to FIG. 5. In this embodiment, engine 85′ has an output shaft 87′ connected to a main gear box 89′. A propeller drive shaft 91′ rotates propeller 76′. Main gear box 89′ has a second output shaft 93′ that is connected to a clutch 103. The opposite side of clutch 103 connects to a drive shaft of an electrical motor 105. Electric motor 105 drives rotor drive shaft 97′, which in turn rotates rotor 73′.

A controller 107 controls the rotational speed of electric motor 105. Controller 107 receives input from flight condition sensors 109, which may be the same as sensors 47 of FIG. 2. Controller 107 may also control the engagement and release of clutch 103.

In the operation of the embodiment of FIGS. 4 and 6, aircraft 61 is designed for inertia jump take-offs, not rotor powered take-offs. The pilot will hold the landing gear brakes on while rotating propeller 76′ and pre-rotating rotor 73′ with engine 85′. Clutch 103 will be engaged so as to transmit torque from gear box output shaft 93′ through the shaft of electric motor 105 to rotor drive shaft 97′. Electrical power will not be supplied to electric motor 105 while clutch 103 is engaged, rather the drive shaft of electric motor 105 will be rotated by engine 85′. The collective pitches of propeller 76′ and rotor 73′ will be near or at zero during pre-rotation. When the desired rotor speed has been achieved, the collective pitches for propeller 76′ and rotor 73′ are changed to a take-off position and the landing gear brakes are released. At the same time, clutch 103 releases, thus removing the driving force of engine 85′ on rotor drive shaft 97′. Rotor 73′ continues to spin due to inertia, but once clutch 93′ is released and aircraft 61 lifts off, there is no reaction torque to counter. Lift will be provided primarily by rotor 73 initially. As the aircraft gains forward speed, wings 69 begin providing lift. The collective pitch of rotor 73′ begins to decrease after lift off. Rotor 73′ will begin to slow, and when the speed nears a minimum rotational speed, controller 107 will cause electric motor 105 to begin supplying torque to rotor drive shaft 97′ to maintain the minimum rotational speed.

At cruise flight, the collective pitch of rotor 73′ will be reduced to zero or near zero. Controller 107 will cause electric motor 105 to rotate rotor 73′ at the minimum slow speed. The pilot will not need to tilt rotor 73′ to cause auto-rotation, rather the rotational force will be coming from electric motor 105. Because rotor 73′ is providing very little lift during cruise flight, there will be very little torque produced by electric motor 105 that needs to be countered.

The embodiment of FIGS. 4 and 6 may undergo a short landing with clutch 103 disengaged. As the aircraft descends, the airstream passes through rotor 73′, causing it to spin more rapidly. Collective pitch is increased, causing rotor 73′ to assume more of the lift and wings 69 to assume less. It will not be necessary to supply electrical power to electric motor 105 during descent because the auto-rotation caused by the airstream flowing through rotor 73′ will spin the shaft of electrical motor 105.

The various embodiments of a rotor drive means eliminate the need to auto-rotate the rotor during cruise flight. In each embodiment, the rotor remains power driven at cruise flight, but in a manner than produces little torque that would need to be countered. Consequently, a tail rotor as in a conventional helicopter is not required.

While the disclosure has been shown in only a few of its forms, it should be apparent to those skilled in the art that it is not so limited but is susceptible to various changes without departing from the scope of the invention.

1. A rotor aircraft, comprising:
an engine having an output shaft;
at least one forward thrust device driven by the engine to provide forward thrust to the aircraft;
wings for providing lift while in forward flight;
a rotor having a rotor drive shaft and mounted for selectively providing lift; and
rotor drive means for selectively providing torque to the rotor drive shaft from the output shaft of the engine at a speed proportional to a speed of the output shaft of the engine while in a first mode and for selectively providing torque to the rotor drive shaft to rotate at a speed independent of a speed of the output shaft of the engine while in a second mode.

2. The rotor aircraft according to claim 1, further comprising:
sensors for sensing flight conditions of the aircraft; and
a controller that controls the rotary drive means while in the second mode in response to input from the sensors.

3. The rotor aircraft according to claim 1, wherein while in the second mode:
the wings are capable of providing substantially all of the lift required during forward flight;
the rotor is capable of being trimmed to provide substantially zero lift; and
the rotor drive means continues to provide torque to the rotor drive shaft to maintain a desired minimum rotational speed of the rotor.

4. The rotor aircraft according to claim 1, wherein the rotor drive means comprises an electric motor coupled to the rotor drive shaft.

5. The rotor aircraft according to claim 4, further comprising:
a clutch between the output shaft of the engine and the rotor drive shaft, the clutch being released while the rotary drive means is in the second mode, thereby disengaging the engine from providing torque to the rotor drive shaft; and
wherein the clutch is located such that the electric motor is able to supply torque to the rotor drive shaft while the clutch is released.

6. The rotor aircraft according to claim 5, wherein while the rotary drive means is in the first mode, the clutch is engaged, thereby causing the output shaft of the engine to apply torque to the rotor drive shaft.

7. The rotor aircraft according to claim 1, wherein the rotary drive means comprises a transmission having an input driven by the output shaft of the engine and an output that is variable in rotational speed relative to the input shaft of the engine.

8. The rotor aircraft according to claim 7, wherein the output of-the transmission is infinitely variable in speed relative to the output shaft of the engine.

9. The rotor aircraft according to claim 7, wherein the transmission has multiple gear ratios of input speed to output speed.

10. A rotor aircraft, comprising:
an engine having an output shaft;
at least one forward thrust device driven by the engine to provide forward thrust to the aircraft;
wings for providing lift during forward flight;
a rotor having a rotor drive shaft and mounted for selectively providing lift;
a clutch located between the output shaft of the engine and the rotor drive shaft, having an engaged position for causing the engine to provide torque to the rotor drive shaft and a disengaged position releasing the output shaft of the engine from driving engagement with the rotor drive shaft; and
an electric motor coupled to the rotor drive shaft for selectively providing torque to the rotor drive shaft while the clutch is in the disengaged position.

11. The rotor aircraft according to claim 10, wherein the electric motor remains coupled to the rotor drive shaft while the clutch is in engaged position and being driven by the engine.

12. The rotor aircraft according to claim 10, further comprising:
sensors for sensing flight conditions of the aircraft; and
a controller that controls the electric motor in response to input from the sensors while the clutch is in the disengaged position.

13. The rotor aircraft according to claim 10, wherein while the clutch is in the disengaged position:
the wings are capable of providing substantially all of the lift required due to forward airspeed;
the rotor is capable of being trimmed to provide substantially zero lift; and
the electric motor provides torque to the rotor drive shaft to maintain a desired minimum rotational speed of the rotor.

14. A rotor aircraft, comprising:
an engine having an output shaft;
at least one forward thrust device driven by the output shaft of the engine to provide forward thrust to the aircraft;
wings for providing lift during forward flight;
a rotor having a rotor drive shaft and mounted for selectively providing lift; and
a transmission having an input-driven by the output shaft of the engine and an output coupled to the rotor drive shaft, the output of the transmission being selectively variable in rotational speed relative to the input shaft of the engine.

15. The rotor aircraft according to claim 14, further comprising:
sensors for sensing flight conditions of the aircraft; and
a controller that controls the output speed of the transmission in response to input from the sensors.

16. The rotor aircraft according to claim 14, wherein:
the rotor aircraft has a forward flight mode wherein the wings provide substantially all the lift;
the rotor may be trimmed to provide substantially zero lift; and
the transmission provides an output speed to the rotor drive shaft to rotate the rotor at a minimum desired speed.
